(19) United States
(12) Patent Application Publication
(10) Pub. No.: US 2002/0196932 A1
(43) Pub. Date: Dec. 26, 2002

(54) Dual mode-configurable digital access mechanism

(75) Inventors: Kevin W. Schneider, Huntsville, AL (US); W. Stuart Venters, Huntsville, AL (US); Michael Scott Sansom, Huntsville, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC.

(21) Appl. No.: 10/216,227

(22) Filed: Aug. 9, 2002

Related U.S. Application Data
(63) Continuation of application No. 09/010,656, filed on Jan. 22, 1998.

(51) Int. Cl. H04M 1/00; H04M 9/00

(52) U.S. Cl. 379/399.01

(57) ABSTRACT

A dual mode phone line connectivity mechanism allows POTS access and digital transport access to coexist over the same local loop serving a customer site, while providing a net DS0 data rate for customer data communications (e.g., either 56 kbps or 64 kbps). When the customer's analog device is on-hook, the connectivity mechanism is configured to provide a digital path for the local loop, so that a digital link, exclusive of voice-processing, is established between a terminal adapter (or super-modem) and the service provider's line interface card, which replaces the voice path with a digital transceiver for the duration of the call. Local loop-associated and network-associated switches selectively provide one of two alternative signalling paths—a voice signalling path containing a codec for POTS signalling, and a data signalling path. A loop current detector monitors the local loop, while a network monitor circuit monitors the network for a ring command signal. Outputs of these monitor circuits are coupled to switch control logic, which also looks for digital equipment wake-up tones and synchronization signals associated with digital access for terminal equipment.

### FIELD OF THE INVENTION

The present invention is directed to communication systems, and is particularly directed to a digital access mechanism for telecommunication networks, that is both compatible with current analog telephony infrastructures, and also provides a link to next generation digital communication services.

### BACKGROUND OF THE INVENTION

Present day (conventional) analog telephone networks, an example of which is diagrammatically illustrated in FIG. 1, are for the most part digital phone networks, in which the principal portion of the end-to-end network 10 is digital, as shown by signalling and DS0 transport clouds 60. Such digital networks are currently configured to transport digitized voice signals as a 56,000 bits per second (56 kbps) or 64,000 bits per second (64 kbps) full duplex digital stream, known as DS0 signals, with opposite ends of the digital portion of the network being terminated by analog interfaces to respective (relatively ‘west’) and (relatively ‘east’) customer sites 20 and 30.

For a west-to-east directed message, as an example, data is transported between source site 20 and destination site 30 using customer modems 22 and 32 (such as V.34 modems using an AT&T 5ESS telephone switch), that are coupled via local loops 40 and 50 to respective interface ends 11 and 12 of the telephone company-provided communication circuit. As a non-limiting example, the local loops may comprise industry standard Resistance Design (RD) and Revised Resistance Design (RRD) Loops. Each local loop 40/50 typically comprises a two-wire analog circuit, commonly termed a Plain Old Telephone Service (POTS) line, which supports analog telephony (denoted by phones 24 and 34), and is interfaced with the digital network by a respective subscriber line interface circuit (SLIC) 41/51, and associated “voice-optimized” μ-law codecs 42/52 of respective interface ends 11 and 12.

The customer site modems 22 and 32, to which subscriber terminal equipments 21 and 31 are respectively coupled, transmit digital information over end-to-end analog phone circuits by means of a relatively sophisticated signal processing scheme, that results in a net full duplex digital rate, which is undesirably less than the basic 56/64 kbps rate available inside the principal digital portion 60 of the network 10. This performance constraint is due to the fact that the signal path between source and destination sites will always encounter the two “voice-optimized” codecs 42 and 52. Typically, such a limited net data rate available to the source and destination sites falls in a range on the order of only 20 to 40 Kbps, depending on the characteristics of the local loops 40 and 50.

Unfortunately, the net data rate of such a conventional network is less than maximum since, even on good phone lines, some information will inherently be lost, as digital-to-analog converters (DACs) installed at each end of the network are tailored for ‘voice signal’ applications. Fortunately, recent advances in modem technology (e.g., 56 k modems) improve upon this restriction, by eliminating the analog conversion at one end of the circuit; still, the overall net rate is less than the basic DS0 rate available inside the ‘digital’ portion of the network.

In order to gain digital access to the network's DS0 signalling capability, customers install a digital subscriber loop—in particular, an Integrated Services Digital Network (ISDN) link. This digital data service, shown in the modified network architectures of FIGS. 2 and 3, permits digital access to the network through the placement of modems at each end of a local phone loop. Although the architectures of FIGS. 2 and 3 require special equipment that is incompatible with standard analog phone service, and even though analog telephony is not supported in FIG. 3 without special equipment, ISDN is still a popular service for digital data communications.

In the architecture of FIG. 2, ISDN modems (or U-chips) 70 and 80 are installed at opposite ends of the (east end) loop 50 associated with east site 30. ISDN U-chip 80 is part of an ISDN terminal adapter 38 that includes call signalling unit 81 and a digital 56 k modem 82, which replaces the modem 32 of FIG. 1. This network architecture also includes a 56 k analog modem 22-2 installed at the west end source site 20, in place of the modem 22 of FIG. 1.

Thus, in the modified network of FIG. 2, signaling connectivity provided to the west site 20 via west end local loop 40 is POTS, whereas the interface provided by terminal adapter 38 of the east end loop 50 is ISDN. This provides the far (east) end ISDN-modem with direct access to the network's DS0 digital data stream. Since these modems operate over a much simpler path than the end-to-end analog phone circuit of FIG. 1, they can operate at greater speeds and, in fact, are capable of passing two DS0 rate circuits to the customer's equipment.

However, such a digital subscriber loop scheme still operates over phone loops that are only somewhat better than those required for basic analog phone service. In the network architecture of FIG. 2, the net data rate available to the (west) source site 20 and the (east) destination site 30 may be as high as 53 kbps, depending on the characteristics of the local loop 40. This performance increase is due to the fact that the modems encounter only one voice codec (codec 42) in the network. It should be noted that 56 k modems do not provide up to 53 kbps data rate in both directions (east-to-west and west-to-east), but only in the direction from the digital connection to the analog connection. (Advantageously, the present invention to be described below avoids this restriction, which is due to the voice-path codec and filtering and the telephone switch, which is bypassed.) It may also be noted that analog (POTS) telephony is only supported at the local (west) end, as shown by phone 24.

In the full bidirectional ISDN architecture of FIG. 3, digital data is transferred between west source site 20 and east destination site 30 using customer terminal adapters 28 and 38, respectively, over the telephone company provided end-to-end digital circuit. In this fully digital architecture, the interface provided to the customers over the respective west and east end local loops 40 and 50 is digital ISDN, providing the terminal adapters 28 and 38 with direct access to the network DS0 digital data stream, via respective U interfaces 75 and 70, respectively.

Advantageously, in the network topography of FIG. 3, the ISDN bearer channel data rate available to the west source site 20 and the east destination site 30 is the same as the DS0 rate in the network—either 56 kbps or 64 kbps, depending upon the characteristics of the network trunk circuits in the DS0 transport cloud 60. Since an ISDN DSL may provide up to two bearer channels, the aggregate data rate available for a circuit switched call is as much as 128 kpbs. The information rate available in the network is also available to the source and destination sites.

Although the full ISDN network architecture of FIG. 3 is capable of providing a net ‘DS0’ data rate—either 56 kbps or 64 kbps, it is not compatible with the basic analog telephone infrastructure needs of the major majority of residential customers. What is preferred is a method that provides access to higher rate digital services and is compatible with basic analog telephony.

### SUMMARY OF THE INVENTION

In accordance with the present invention, the above described customer preference is accommodated by selectively replacing the digital-to-analog conversion function at opposite ends of the network with an optimized modem that is configured for digital access or data calls, and effectively circumvents the data rate-constraining components that are necessarily encountered in conventional digital data transmission schemes that provide for POTS capability. As will be described, the invention provides a robust dual mode phone line mechanism, that allows both analog telephony and digital access to employ the same physical loop, with digital access using the same band as voice (although not simultaneously), so as to be compatible with current communication network infrastructures, and without constraining the effective data rate to less than that (e.g., DS0) of the network.

For this purpose, the dual mode-configurable digital access mechanism of the present invention essentially comprises a combination of conventional POTS and data connectivity (ISDN) system architectures, and is augmented to include two replacement components associated with a terminating (customer) end portion of the network. These additional components include a customer premises-installed “super modem” or (ISDN) terminal adapter, and a modified line interface unit installed at the network end of a local loop. Advantageously, since the local loop supports standard analog telephony, and requires no special conditioning, both a source customer site and a destination customer site may access the full network DS0 rate.

The replacement or modified line interface unit is configured to include a loop side interface, that is connected to the local loop, and a network or (central office) switch side interface that is connected to the network's DS0 and signalling transport paths. A dedicated signalling path is coupled between the loop side interface and the switch side interface. On the local loop side, a first path switch selectively provides a path between the loop side interface and a selected one of two mutually exclusive signalling paths: 1) a voice signalling path containing a (μ-law) codec for POTS signalling, and 2) a full DS0 data rate data signalling path. On the network side, a second path switch selectively provides a path between the switch side interface and one of the voice and data paths available from the first path switch at the local loop side of the modified line interface.

A loop current monitor circuit monitors the loop side interface for an off-hook condition (the presence of loop current) associated with analog POTS signalling), while a network monitor circuit is coupled to the switch side interface and monitors the network for the presence of a ring command signal. Outputs of these monitor circuits are coupled to a control logic unit, which also monitors the modem path for the presence of digital equipment wake-up tones and synchronization signals associated with the operation of the local loop customer's super modem.

The control logic unit is operative to control the functionality of the line circuit interface, including ringing the customer's phone through the loop side interface, notifying the network that the customer's phone is off-hook, via the switch side interface, controlling voice and data path connectivities through the path switches, and enabling the modem. The actions of the control logic unit are dependent on the states of its inputs and a set of operating rules, to be described.

In analog (POTS) mode, which is the default mode in order to preserve POTS lifeline capability, the modified line circuit provides a voice path that includes a (μ-law) codec between the local loop and the network; in digital access mode, a data only path—exclusive of any such (μ-law) codec—is provided between the local loop and the network. Which connectivity mode is to be employed is based upon the output of the loop current monitor circuit. If an off-hook condition (loop current) is detected, analog POTS mode of operation is inferred, and the modified line interface is forced into analog POTS mode, using a digital/analog conversion circuity of a (μ-law) codec, through the voice path, to preserve lifeline POTS capability.

However, during the on-hook state or in absence of loop current, the modified line interface provides a direct data transport path between its loop side interface and switch side interface. The customer's modem will then look for digital equipment-associated wake-up and training sequences, while preserving the ability to transmit analog signals to support POTS caller ID and ring functionality. If a valid digital equipment wake-up or training sequence is detected, then the modem will temporarily disable caller ID and ring support and attempt to train up the local loop. Once the loop is trained, the modem will to enter full digital mode, where all signaling (except lifeline POTS loop current detect) is carried out via the modem path, and avoiding the data rate constraints that encountering a (μ-law) codec would otherwise produce. Failure in training or full digital mode will cause the modem to revert or default back to analog mode, thereby preserving lifeline POTS capability.

When the network architecture of the invention is operating in full digital mode, it may be used to connect a digital data stream provided by the modem to a packet-switched network, instead of a telephony network. This application is particularly useful where many data customers have usage statistics that suit the characteristics of a packet-switched network better than they do a circuit-switched telephony network. This modification is also beneficial to the telephone company and is transparent to the customer. Where a connection to the packet-switched network is provided, a further application is to increase the bit rate of the super modem, depending on the characteristics of the loop. Given the extra bandwidth and suitable customer equipment, an additional extension is to carry the original voice traffic over the modem bit stream, thus allowing the modem to stay in full digital mode for simultaneous voice and data.

### BRIEF DESCRIPTION OF THE DRAWINGS

FIG. 1 diagrammatically illustrates a conventional analog telephone network, in which the principal portion of the end-to-end network is digital, and local end loops of which are terminated by analog modems;

FIG. 2 diagrammatically illustrates a conventional digital data services telephone network having a (56 k) analog modem and an ISDN modem terminating local loops with customer premises equipment;

FIG. 3 diagrammatically illustrates a conventional full ISDN digital data services telephone network using customer terminal adapters to provide direct access to a DS0 digital data stream;

FIG. 4 shows a telephone network architecture according to the present invention providing a data connection between a super modem and an ISDN terminal adapter;

FIG. 5 diagrammatically illustrates details of the modified line interface of FIG. 4; and

FIG. 6 diagrammatically illustrates a non-limiting example of an implementation of a super modem as a digital data service terminal adapter.

### DETAILED DESCRIPTION

Before describing in detail the dual mode-configurable digital access mechanism of the present invention, it should be observed that the invention primarily resides in what is effectively a prescribed arrangement of conventional communication circuits and associated digital signal processing components and attendant supervisory control routines, that control the operations of such circuits and components. Consequently, the configuration of such circuits and components and the manner in which they are interfaced with other communication system equipment have, for the most part, been illustrated in the drawings by readily understandable block diagrams, which show only those specific details that are pertinent to the present invention, so as not to obscure the disclosure with details which will be readily apparent to those skilled in the art having the benefit of the description herein. Thus, the block diagram illustrations and the connectivity control sequence to be described are primarily intended to present the major components of the system in a convenient functional grouping and signal processing sequence, whereby the present invention may be more readily understood.

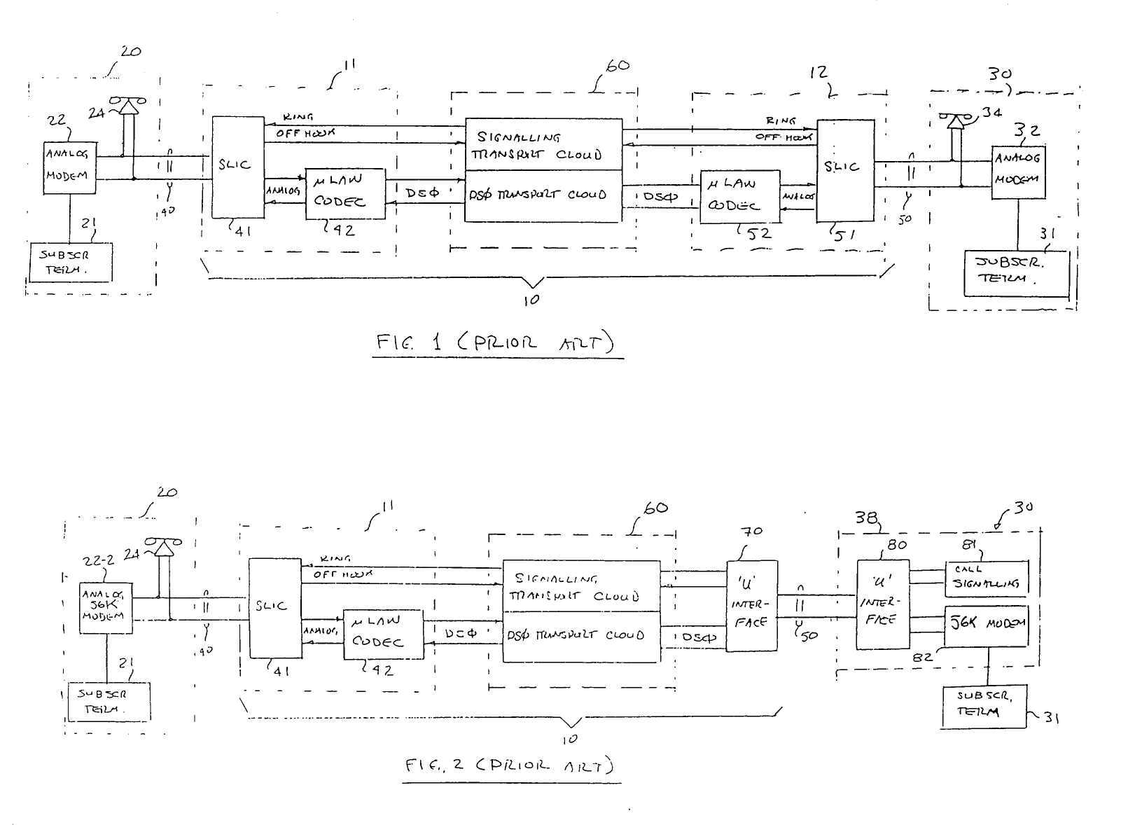

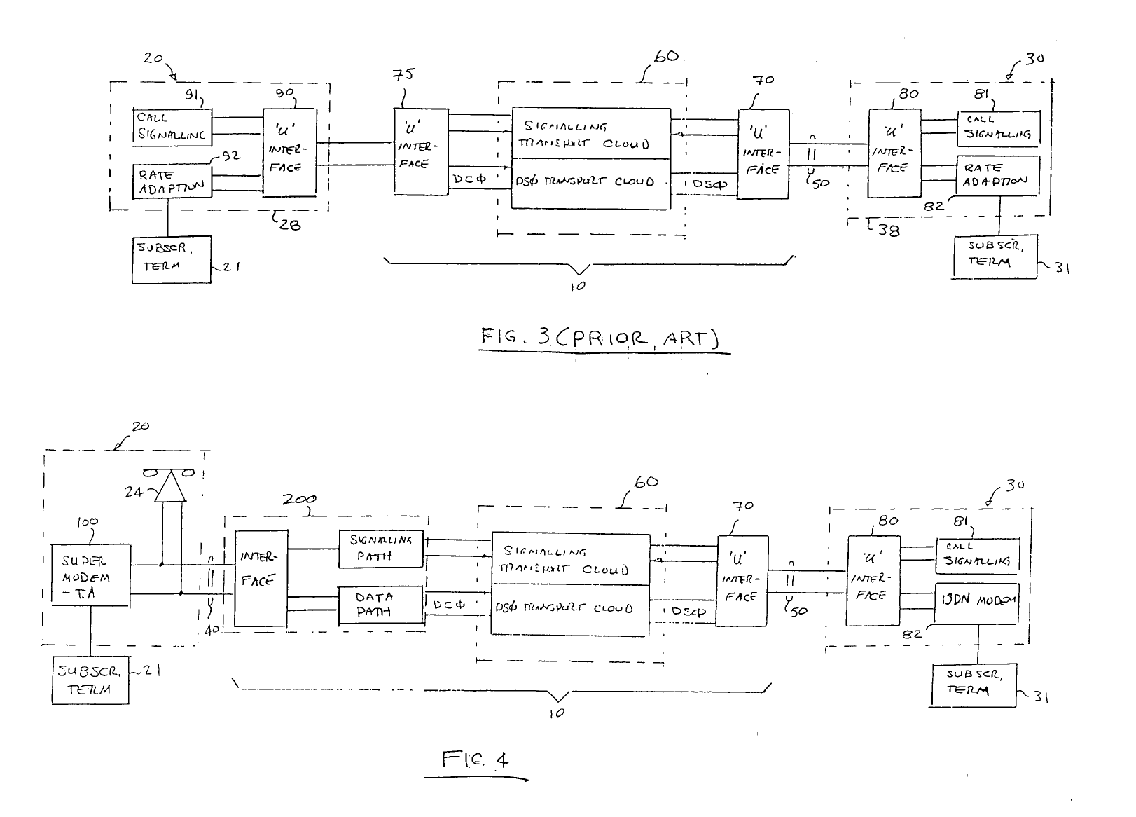

As described briefly above, and as is diagrammatically illustrated in FIG. 4, the dual mode-configurable digital access mechanism of the present invention is a combination of the conventional system architectures of FIGS. 1 and 3, and augmented to include two replacement components associated with the near end portion of the network—1) a customer premises-installed ‘super’-modem 100, and 2) a modified line interface unit 200. In contrast to the near end ISDN loop used in FIG. 3, the near end local loop 40 of FIG. 4 does not require special conditioning. As a result, the source site 20 and destination site 30 have access to the full network DS0 rate; still, standard analog telephony is supported, as depicted by telephone 24.

As a non-limiting example, super modem 100 may comprise a digital data service terminal adapter, such as that shown diagrammatically in FIG. 6 as comprising a loop side interface 102 coupled to the local loop 40, and a control and protocol processor 104, coupled to the subscriber's terminal equipment 21. Also coupled to the local loop 40 is a loop voltage detector 106, which monitors the loop for the presence of a loop voltage and couples a corresponding detection signal to the processor 104. A modem 108 is installed between the loop side interface 102 and the processor 104.

Although the modified line interface unit 200 of FIG. 4 is shown as being installed with the telephone service provider's equipment, such as in place of an analog line card of an industry standard AT&T-5ESS ISLU platform, it may also be installed at other locations in the network where a codec is used. Typical examples are other 5ESS line cards and line cards in TR-08 and GR-303 remote channel banks. Similarly, although the super modem 100 is shown as a stand-alone unit installed at the customer site 20, it may be incorporated into another piece of equipment, such as a computer or router.

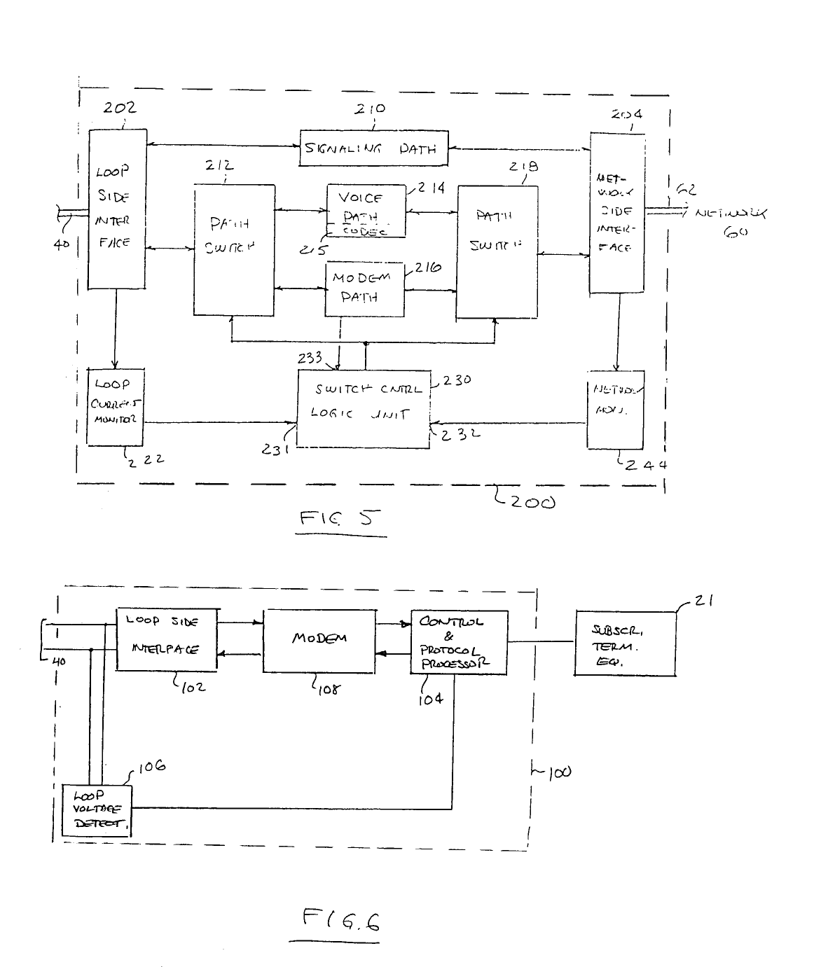

The modified line interface unit according to the present invention is diagrammatically illustrated in detail in FIG. 5 as comprising a loop side interface 202 connected to the near end customer loop 40, and a network or switch side interface 204, connected to the network's DS0 and signalling transport paths 62. A signalling/control path 210, separate from that used for data/voice transport, is coupled between loop side interface 202 and the switch side interface 204. A first, customer side path switch 212 is coupled to provide a path between the loop side interface 202 and one of a voice path 214 and a data or modem path 216 under the control of a dual switch-controlling logic unit 230. The voice path 214 includes a codec 215 for interfacing between analog POTS signals and DS0 signals. As non-limiting examples, the modem path function may be provided using one of many different modulation formats, such as 2B1Q (T1.601), QAM, multicarrier modulation, or the simple coded pulse amplitude modulation scheme described in co-pending U.S. patent application Ser. No. 08/560,812, filed Nov. 20, 1995, by M. Turner et al, entitled: “Use of Modified Line Encoding and Low Signal-to-Noise Ratio Based Signal Processing to Extend Range of Digital Data Transmission Over Repeaterless Two-Wire Telephone Line,” assigned to the assignee of the present application and the disclosure of which is incorporated herein.

On the other hand, modem path 216 contains no voice-processing components (such as those associated with a μ-law codec used in POTS signalling) and therefore provides an essentially unencumbered direct connectivity path between the super-modem 100 at the customer site 20 and the network. A second, switch side path switch 218 is coupled to provide a path between the switch side interface 204 and one of the voice path 214 and modem path 216 under control of dual switch controlling logic unit 230.

A loop current monitor circuit 222 is coupled to the loop side interface 202 and is operative to monitor the local loop for the presence of loop current. A signal representative of a local off-hook condition (whether or not loop current is present) is coupled from loop current monitor circuit 222 to a first input 231 of control logic unit 230. Similarly, a network monitor circuit 244 is coupled to the switch side interface 204 and is operative to monitor the network for an incoming POTS call (the presence of a ring command signal). A signal indicative of whether or not a ring command signal is detected is coupled from network monitor circuit 244 to a second input 232 of control logic unit 230. The switch control logic unit 230 has a third input 233 coupled to the modem path 216 for monitoring the presence of digital terminal equipment-associated wake-up tones and synchronization signals associated with the operation of the super-modem 100.

The dual switch controlling logic unit 230 is preferably implemented as a programmable logic array chip, and is programmed to execute control actions which include: 1) ringing the local customer's phone 24 through the loop side interface 202; 2) notifying the network that the customer's phone 24 is off-hook, via the switch side interface 204; 3) controlling connectivities through the path switches 212 and 218; and 4) enabling the modem. The actions of the control unit 230 are dependent on the states of its inputs and a set of operating rules, described below.

More particularly, in analog (POTS) mode, switch control logic unit 230 places the customer side path switch 212 in a ‘POTS-connectivity’ state, that couples the loop side interface 202 to the voice path 214, and the switch side path switch 218 in a like POTS-connectivity state, that couples the voice path 214 to the switch side interface 204. In digital access or data transport mode, control logic unit 230 places the customer side path switch 212 in a ‘data-connectivity’ state, that couples the loop side interface 202 to the modem path 216. It also places the switch side path switch 218 in a data-connectivity state—coupling modem path 216 to the switch side interface 204.

For this purpose, whenever loop current is detected by loop current monitor circuit 222—indicating an off-hook condition for POTS mode of operation—the modified line interface 200 is forced into (default) analog POTS mode, thereby preserving lifeline POTS capability, as noted above. In response to a loop current detection signal being applied to its input 231 from loop current monitor circuit 222, the switch control logic unit 230 operates the customer side path switch 212 and switch side path switch 218, so as to provide codec analog/digital conversion connectivity through voice path 214, thereby providing an analog POTS interface that replicates the functions-of a SLIC, codec, and switch interface, described above with reference to FIG. 1.

On the other hand, when the customer device (POTS phone 24) is on-hook (no loop current flows), the local loop 40 from the switch to the customer site 20 is converted to a digital line. This serves to establish a digital communication link between the customer's terminal adapter (super-modem) 100 and the service provider's modified line interface circuit 200, which replaces the voice path with a digital transceiver for the duration of the call. Namely, if the loop current input 231 to control logic unit 230 does not indicate the presence of loop current, the switch control logic unit 230 operates the customer side path switches 212 and 218 to couple modem path 216 to each of the loop side interface 202 and switch side interface 204.

It should be noted that, although, for purposes of providing a reduced complexity example, modem path 216 and voice path 214 are shown as separate and distinct paths, these two (logical) paths may share some of the same physical hardware. For example, the voice path codec may be implemented using the modem path's analog-to-digital conversion and signal processing capabilities.

The modem path 216 will look for the above-referenced wake-up and training sequences, while preserving the ability to transmit analog signals to support POTS caller ID and ring functionality. If a valid digital terminal equipment-associated wake-up or training sequence is detected, the modem path will temporarily disable caller ID and ring support and attempt to train up the loop 40. Once the loop is trained, the link will enter full digital mode, where all signaling (except lifeline POTS loop current detect) is carried out via the modem information stream carried over the unencumbered or optimal data rate modem path 216. Failure in training or full digital mode will cause the super-modem to revert to the listening mode.

As mentioned previously, when the network architecture of the invention is operating in full digital data transport mode, it may be readily employed to connect the digital stream provided by the super-modem 100 to a packet-switched network, instead of a telephony network. This application is especially useful where a significant number of data customers have usage statistics that are more suited to the characteristics of a packet-switched network than a circuit-switched telephony network. Such a straightforward modification is beneficial to the telephone company and effectively transparent to the customer. Where such a connection to a packet-switched network is provided, the bit rate of the super-modem 100 may be increased, depending on the characteristics of the loop. Given added bandwidth and suitable customer equipment, an additional extension is to carry the original voice traffic over the modem bit stream, thus allowing the modem to stay in full digital mode for simultaneous voice and data.

As will be appreciated from the foregoing description, the above described objective of providing a net DS0 data rate for customer data communications (e.g., either 56 kbps or 64 kbps), while at the same time being compatible with the basic analog telephone infrastructure needs of a majority of residential customers, is successfully addressed by the robust dual mode phone line mechanism of the present invention, that allows analog telephony and digital access to use the same local physical loop serving the customer site.

By using a line that normally operates as a conventional analog phone line, the present invention facilitates providing full digital data transport service to all analog subscribers served by standard local loops, such as, but not limited to Resistance Design (RD) and Revised Resistance Design (RRD) Loops, referenced above, and also some loops designed by other rules. Where the customer device is on-hook (no loop current flows), the local loop from the switch to the customer is configured as a digital line, and a digital communication link is established between the customer's terminal adapter (super-modem) and the service provider's line interface card, which replaces the voice path with a digital transceiver for the duration of the call.

Advantageously, the invention is relatively simple for the operating company to deploy, since it does not require service personnel to leave the central office (if the customer line is served directly out of the switch) and can be installed on nearly all analog lines. Moreover, the invention does not suffer from the lifeline problems of ISDN, since an analog phone line is already in place. Also, the invention requires no special customer premise-located electronics for analog line operation. Digital access is similar to that of an analog modem, except that the modulated signal is terminated at the modified line interface. Since no voice band μ-law codec is encountered in the digital data transport path, the data rate can be increased relative to that of a conventional analog modem, such as V.34.

The present invention is particularly well suited for an application where the majority of digital calls are outgoing calls, as it provides opportunity for the digital link to train up, either while the call is being connected or before the call is connected, thereby achieving the relatively rapid call connect times of an ISDN line. Although the transported data stream will be delayed somewhat, while the digital link trains up (making it somewhat less desirable than ISDN for applications that receive a relatively large number of calls), this is not a significant disadvantage for the average residential customer, who will primarily be dialing up an on-line (internet) service provider. This delay can be reduced to an acceptable amount by employing a quick-train or warm start capability for the modem path, similar to that defined by industry standard T1.601 for 2B1Q modulation.

As noted above, in addition to providing digital access to the telephony network, the invention may also be used to provide digital access to statistically based networks. In this case, the access mechanism is capable of operating at speeds higher than the 56/64 kbps DS0 rate, depending on the loop and modem technology available. This enables the invention to provide a seamless, incremental upgrade path from the current universal telephony network to next generation universal data/voice networks.

While we have shown and described an embodiment in accordance with the present invention, it is to be understood that the same is not limited thereto but is susceptible to numerous changes and modifications as are known to a person skilled in the art, and we therefore do not wish to be limited to the details shown and described herein, but intend to cover all such changes and modifications as are obvious to one of ordinary skill in the art.

What is claimed:

1. A dual mode connectivity mechanism for providing analog telephony and digital access within a common bandwidth of the same local loop, through which digital terminal equipment and plain old telephone service (POTS) equipment associated with a subscriber site are coupled to a communication network comprising:
a first path selectively coupled between said local loop and said network, and being operative to provide POTS signaling connectivity over said local loop;
a second path selectively provided between said local loop and said network, exclusive of voice-processing circuitry, and being operative to couple digital signaling connectivity over said local loop; and
a switching arrangement which is controllably operative to couple said local loop with said network by way said first path in response to detecting a signalling condition associated with a POTS call from either said local loop or said network, and is operative to couple said local loop with said network by way said second path in the absence of detecting said signalling condition associated with a POTS call from either said local loop or said network.

2. A dual mode connectivity mechanism according to claim 1, wherein said signalling condition associated with a POTS call corresponds to at least one of loop current flow through said local loop and a ring command signal from said network.

3. A dual mode connectivity mechanism according to claim 1, wherein said switching arrangement is controllably operative to couple said local loop with said network by way said second path in response to detecting at least one of digital equipment wake-up tones, training sequence signals and synchronization signals associated with the operation of said digital terminal equipment.

4. A dual mode connectivity mechanism according to claim 1, wherein said switching arrangement is operative, in the absence of loop current flow through said local loop, to monitor said second path for said digital equipment wake-up tones or synchronization signals, while preserving the ability of said first path to transmit analog signals to support analog service for said local loop.

5. A dual mode connectivity mechanism according to claim 2, wherein said switching arrangement includes a local loop current detector, and a network monitor circuit operative to monitor said network for a ring command signal.

6. A dual mode connectivity mechanism according to claim 3, wherein said switching arrangement is operative, in response to not detecting said digital equipment wake-up tones or synchronization signals, to maintain connectivity through said first path between said network and said local loop to said analog telephone equipment.

7. A dual mode connectivity mechanism according to claim 1, wherein said prescribed data rate is DS0 data rate.

8. A dual mode connectivity mechanism according to claim 1, wherein said first path is a default path.

9. A method of providing plain old telephone service (POTS) access and digital access over a common bandwidth of the same local loop, through which digital terminal equipment and analog telephone equipment associated with a subscriber site are coupled to a communication network, said method comprising the steps of:
(a) in response to a first condition associated with the use of said analog telephone equipment, providing a first POTS path between said local loop and said network; and
(b) in response to a second condition associated with the use of said digital terminal equipment, and in the absence of a signaling condition associated with a POTS call, providing a second path, exclusive of analog voice-processing circuitry, between said local loop and said network, said second path being operative to couple digital signals conveyed over said local loop at a prescribed data rate from said digital terminal equipment to said network, and to couple digital signals at said prescribed data rate from said network to said local loop for transport thereby to said digital terminal equipment.

10. A method according to claim 9, wherein step (b) includes, in the absence of step (a) detecting said first condition, monitoring said second path for said second condition, while preserving the ability of step (a) to provide said first path for the transmission of POTS associated signals to support POTS service for said local loop.

11. A method according to claim 9, wherein said prescribed data rate is DS0 data rate.

12. A method according to claim 9, wherein said first path is a default path.

13. A method according to claim 9, wherein said first condition includes at least one of loop current flow through said local loop and a ring command signal from said network, and said second condition includes at least one of digital equipment wake-up tones, training sequence and synchronization signals associated with the operation of said digital terminal equipment.

14. A method according to claim 13, wherein step (a) comprises, in response to step (b) not detecting said digital equipment wake-up tones or synchronization signals, maintaining connectivity through said first path between said network and said local loop to said POTS telephone equipment.
